(19) United States
(12) Patent Application Publication
(10) Pub. No.: US 2010/0132673 A1
(43) Pub. Date: Jun. 3, 2010

(54) VARIABLE COMPRESSION RATIO APPARATUS FOR VEHICLE ENGINE

(75) Inventor: Ki Wook BYEON, Hwaseong-city (KR)

Correspondence Address: MORGAN, LEWIS & BOCKIUS LLP (SF), One Market, Spear Street Tower, Suite 2800, San Francisco, CA, 94105, US

(73) Assignee: Hyundai Motor Company, Seoul (KR)

(21) Appl. No.: 12/612,485

(22) Filed: Nov. 4, 2009

(30) Foreign Application Priority Data
Nov. 28, 2008 (KR) 10-2008-0120107

(51) Int. Cl. F02B 75/04

(52) U.S. Cl. 123/48 B

(57) ABSTRACT

A variable compression ratio apparatus for a vehicle engine that is mounted at the engine and rotating a crankshaft mounted between upper and lower cylinder blocks, and that changes compression ratio of the air-fuel mixture by changing a mounting height of the crankshaft according to a driving condition of the engine, may include a supporter having a lower surface formed of a slanted surface and mounted between the upper and lower cylinder blocks, the crankshaft being rotatably inserted in the supporter through a bearing, an elastic member mounted at an upper portion of the supporter, a slider slidingly contacted to the slanted surface of the supporter and supported by the lower cylinder block, an operation unit applying operating force to the slider, and a power delivery unit connecting the slider with the operation unit and transmitting the operating force of the operation unit to the slider.

### CROSS-REFERENCE TO RELATED APPLICATION

This application claims priority to Korean Patent Application No. 10-2008-0120107 filed in the Korean Intellectual Property Office on Nov. 28, 2008, the entire contents of which are incorporated herein for all purposes by this reference.

### BACKGROUND OF THE INVENTION

1. Field of the Invention

The present invention relates to a vehicle engine. More particularly, the present invention relates to a variable compression ratio apparatus that changes compression ratio of an air-fuel mixture in a combustion chamber according to a driving condition of the engine.

2. Description of Related Art

Generally, thermal efficiency of combustion engines increases as the compression ratio thereof increases, and if ignition timing is advanced to some degree, thermal efficiency of spark-ignition engines increases.

However, if the ignition timing of the spark-ignition engines is advanced at a high compression ratio, abnormal combustion may occur and the engine may be damaged. Thus, the ignition timing cannot be excessively advanced and accordingly engine output may deteriorate.

A variable compression ratio (VCR) apparatus changes the compression ratio of an air-fuel mixture according to a driving condition of the engine.

The variable compression ratio apparatus raises the compression ratio of the air-fuel mixture at a low-load condition of the engine in order to improve fuel mileage. On the contrary, the variable compression ratio apparatus lowers the compression ratio of the air-fuel mixture at a high-load condition of the engine in order to prevent occurrence of knocking and improve engine output.

Currently, diesel engines achieve low-temperature combustion by enlarging the volume of a combustion chamber and by lowering the compression ratio in order to meet intensified exhaust gas regulations.

However, since startability at a cold temperature deteriorates as the compression ratio decreases, a glow plug system must be made of ceramic materials so as to strengthen them and an additional control unit for controlling the glow plug system is required. Thus, production costs may increase.

In addition, since the compression ratio is fixed, an optimal compression ratio according to a various driving conditions may not be achieved.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY OF THE INVENTION

Various aspects of the present invention are directed to provide a variable compression ratio apparatus for a vehicle engine having advantages of enhancing fuel mileage and output as a consequence of changing compression ratio of an air-fuel mixture according to a driving condition of an engine.

In one aspect of the present invention, a variable compression ratio apparatus for a vehicle engine that is mounted at the engine receiving combustion force of air-fuel mixture from a piston and rotating a crankshaft mounted between upper and lower cylinder blocks, and that changes compression ratio of the air-fuel mixture by changing a mounting height of the crankshaft according to a driving condition of the engine, wherein the mounting height is a distance between a cylinder head and the crankshaft, may include a supporter having a lower surface formed of a slanted surface and mounted between the upper and lower cylinder blocks so as to be movable therein, wherein the crankshaft is rotatably coupled to the supporter, an elastic member mounted at an upper portion of the supporter in the upper cylinder block so as to apply an elastic force to the supporter, a slider slidingly contacted to the slanted surface of the supporter so as to move the supporter toward or away from a cylinder and thus control the mounting height and slidingly supported by the lower cylinder block so as to be movable in a perpendicular direction to the slider, an operation unit rotatably mounted on the lower cylinder block and applying an operating force to the slider, and a power delivery unit connecting the slider with the operation unit to transmit the operating force of the operation unit to the slider.

The supporter may be mounted at a supporter mounting portion located at a connecting position of the upper and lower cylinder blocks and is configured to be movable in the supporter mounting portion.

The supporter mounting portion is a groove formed in the upper and lower cylinder blocks toward the cylinder to slidingly receive the supporter therein.

The elastic member may be mounted in at least one spring mounting recess formed on an upper end portion of the supporter mounting portion and is contacted with an upper surface of the supporter so as to apply the elastic force thereto.

The slider may be provided with a slip surface slidingly contacted with the slanted surface of the supporter so as to control the mounting height of the crankshaft.

The operation unit may include a control shaft provided with a cam member eccentrically connected to the slider through the power delivery unit, and a drive motor connected to the control shaft and applying torque to the control shaft.

The power delivery unit may be provided with at least a link member pivotably connected to the slider and the cam member respectively.

The power delivery unit may include a first rack integrally formed at one end portion of the slider, and a second rack integrally formed at the cam member and engaged with the first rack.

The supporter may include an upper supporter mounted in the upper cylinder block, and a lower supporter provided with the slanted surface and mounted in the lower cylinder block.

The upper supporter and the lower supporter may be formed separately.

The crankshaft may be rotatably coupled to the supporter through a bearing.

The supporter may include an upper supporter and a lower supporter and the bearing has a hollow cylindrical shape, an interior circumference and an exterior circumference of which have the same center, and includes an upper bearing mounted in the upper supporter and a lower bearing mounted in the lower supporter, wherein the upper bearing and the lower bearing are formed separately.

The upper and lower cylinder blocks may be formed monolithically.

In another aspect of the present invention, a variable compression ratio apparatus for a vehicle engine that is mounted at the engine receiving combustion force of air-fuel mixture from a piston and rotating a crankshaft mounted between upper and lower cylinder blocks, and that changes compression ratio of the air-fuel mixture by changing a mounting height of the crankshaft according to a driving condition of the engine, wherein the mounting height is a distance between a cylinder head and the crankshaft, may include a supporter provided with an upper surface, a lower surface formed of a slanted surface, and a middle portion at which the crankshaft are rotatably coupled, and being movable toward or away from a cylinder in the engine, a slider provided with an upper surface corresponding to the slanted surface of the supporter and a flat lower surface, and being movable in a perpendicular direction to a movement direction of the supporter, and an operation unit connected to the slider, and applying an operating force to the slider so as to move the slider in the perpendicular direction, wherein a movement of the slider is converted into a movement of the supporter by the slanted surface of the supporter and the upper surface of the slider slidingly contacted with each other, and thereby the mounting height of the crankshaft is changed, and wherein an elastic member may apply elastic force against the operating force of the operation unit to the supporter, and wherein the operation unit selectively applies the operating force to the slider according to the driving condition of the engine.

The methods and apparatuses of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a schematic diagram of a variable compression ratio apparatus for a vehicle engine according to an exemplary embodiment of the present invention.

FIG. 2 is a side cross-sectional view of FIG. 1.

FIG. 3 is a perspective view showing primary constituents of a variable compression ratio apparatus for a vehicle engine according to an exemplary embodiment of the present invention.

FIG. 4 to FIG. 6 are schematic diagram showing an operation of a variable compression ratio apparatus for a vehicle engine according to an exemplary embodiment of the present invention.

FIG. 7 is a side cross-sectional view of a variable compression ratio apparatus for a vehicle engine according to another exemplary embodiment of the present invention.

FIG. 8 to FIG. 10 are schematic diagram showing an operation of a variable compression ratio apparatus for a vehicle engine according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION OF THE INVENTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

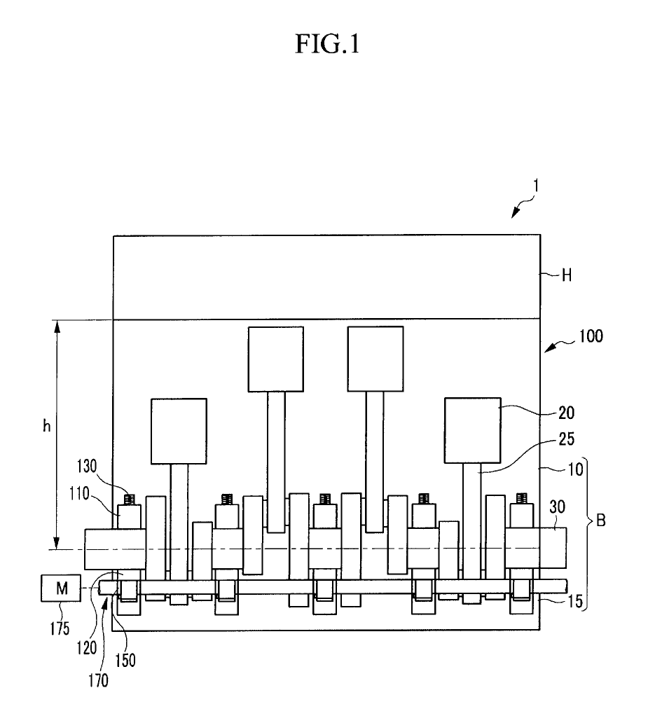

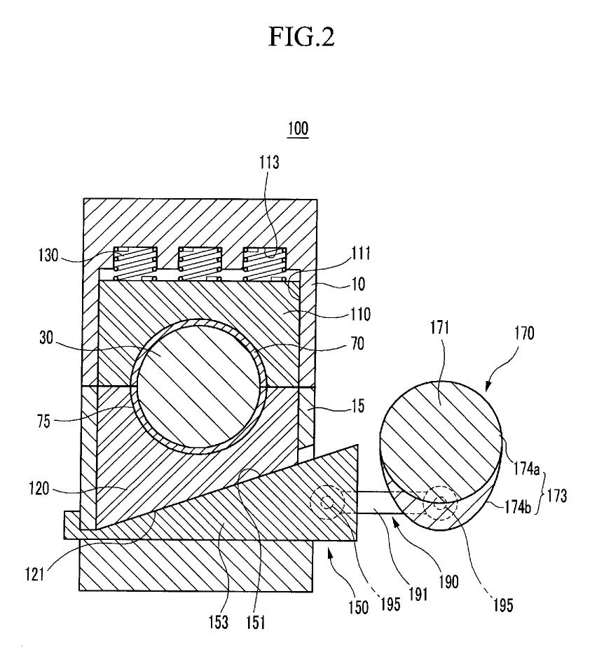

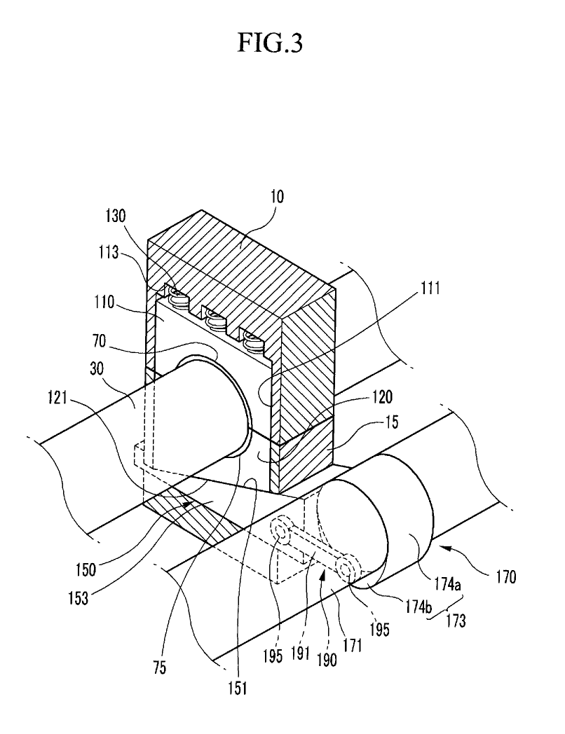

FIG. 1 is a schematic diagram of a variable compression ratio apparatus for a vehicle engine according to an exemplary embodiment of the present invention; FIG. 2 is a side cross-sectional view of FIG. 1; and FIG. 3 is a perspective view showing primary constituents of a variable compression ratio apparatus for a vehicle engine according to an exemplary embodiment of the present invention.

Referring to the drawings, a variable compression ratio apparatus 100 for a vehicle engine according to an exemplary embodiment of the present invention changes a mounting height h of a crankshaft 30 according to a driving condition of an engine 1.

The engine 1 includes a cylinder head H and a cylinder block B, and the cylinder block B includes an upper cylinder block 10 and a lower cylinder block 15.

An ignition device, an intake valve, an exhaust valve, and a valve opening device are mounted at the cylinder head H.

In addition, a cylinder is formed in the engine 1, and a piston 20 is inserted in the cylinder so as to form a combustion chamber between the cylinder and the piston 20.

The combustion chamber is connected to an intake manifold so as to receive an air-fuel mixture, and is connected to an exhaust manifold so as to exhaust the burnt air-fuel mixture.

One end of a connecting rod 25 is rotatably connected to the piston 20, and the other end of the connecting rod 25 is eccentrically and rotatably connected to the crankshaft 30.

The crankshaft 30 is a mounted at a connecting position of the upper cylinder block 10 and the lower cylinder block 15. The crankshaft 30 receives combustion force from the piston 20, converts the combustion force into torque, and transmits the torque to a transmission.

Therefore, the combustion force of the air-fuel mixture transmitted from the piston 20 to the connecting rod 25 is transmitted to the crankshaft 30 and rotates the crankshaft 30.

The variable compression ratio apparatus 100 according to an exemplary embodiment of the present invention is mounted in the cylinder block B of the engine 1. The variable compression ratio apparatus 100 changes compression ratio of the air-fuel mixture by changing the mounting height h of the crankshaft 30 according to the driving condition of the engine 1.

The variable compression ratio apparatus 100 includes supporters 110 and 120, an elastic member 130, a slider 150, an operation unit 170, and a power delivery unit 190, and these constituents will be described in detail.

According to the present exemplary embodiment, the supporters 110 and 120 are mounted between the upper and lower cylinder blocks 10 and 15, and are configured to be movable upwardly or downwardly in the upper and lower cylinder blocks 10 and 15 respectively.

The supporters 110 and 120 are mounted at a supporter mounting portion 111 located at the connecting position of the upper and lower cylinder blocks 10 and 15. The supporter mounting portion 111 is a space formed as a groove in the upper and lower cylinder blocks 10 and 15.

That is, the supporters 110 and 120 can move upwardly or downwardly in a state of being supported by the supporter mounting portion 111.

For this purpose, height of the supporters 110 and 120 are smaller than that of the supporter mounting portion 111, and thus, the supporters 110 and 120 can move upwardly or downwardly in the supporter mounting portion 111.

Here, the supporters 110 and 120 includes an upper supporter 110 mounted at the upper cylinder block 10 and a lower supporter 120 mounted at the lower cylinder block 15, and the upper supporter 110 and the lower supporter 120 are formed as blocks in an exemplary embodiment.

In the drawings, the upper supporter 110 and the lower supporter 120 are formed separately and then are assembled with each other. However, the present invention is not limited to this, and the upper supporter 110 and the lower supporter 120 may be formed integrally.

In addition, bearings 70 and 75 are mounted in the supporters 110 and 120, that is, between the upper supporter 110 and the lower supporter 120. The crankshaft 30 is rotatably inserted in the bearings 70 and 75.

The bearings 70 and 75 reduce friction generated when the crankshaft 30 rotates, and have a hollow cylindrical shape.

The bearings 70 and 75 have an annular shape, an interior circumference and an exterior circumference of which have the same center, and include an upper bearing 70 mounted at the upper supporter 110 and a lower bearing 75 mounted at the lower supporter 120.

In this case, lubrication oil may be supplied to the interior circumference of the bearings 70 and 75 for smooth rotation of the crankshaft 30.

In the drawings, the upper bearing 70 and the lower bearing 75 are formed separately and then are assembled with each other. However, the present invention is not limited to this, and the upper bearing 70 and the lower bearing 75 may be formed integrally.

In the supporters 110 and 120, a slanted surface 121 slanted downwardly from one side (the right side in FIG. 2) to the other side (the left side in FIG. 2) is formed on a lower surface of the lower supporter 120.

According to the present exemplary embodiment, the elastic member 130 applies elastic force against operating force of the operation unit 170 downwardly to the supporters 110 and 120.

The elastic member 130 may be a coil spring and is mounted at an upper portion of the supporters 110 and 120. In an exemplary embodiment of the present invention, a plurality of the elastic member 130 is mounted in a plurality of spring mounting recesses 113 formed on an upper end of the supporter mounting portion 111.

Since a lower end portion of the elastic member 130 is contacted to the upper supporter 110, the elastic member 130 applies the elastic force to the upper supporter 110. That is, the elastic member 130 always applies the elastic force to the supporters 110 and 120 downwardly in the drawings.

Therefore, the supporters 110 and 120 moves downwardly or upwardly in the supporter mounting portion 111 of the cylinder block B by the elastic force of the elastic member 130 or the operating force of the operation unit 170.

According to the present exemplary embodiment, the slider 150 moves the supporters 110 and 120 downwardly or upwardly in the supporter mounting portion 111.

The slider 150 is slidingly contacted to the slanted surface 121 of the lower supporter 120, and is movably reciprocatively supported by the lower cylinder block 15.

That is, in a state that an upper surface of the slider 150 supports the slanted surface 121 of the lower supporter 120 and a lower surface of the slider 150 is slidably supported on a lower end of the supporter mounting portion 111, the slider 150 can reciprocate horizontally.

Here, the slider 150 is provided with a slip surface 151 slidingly contacted to the slanted surface 121 of the lower supporter 120.

The slip surface 151 is slanted upwardly from the other side (the left side in FIG. 2) to the one side (the right side in FIG. 2) corresponding to the slanted surface 121 of the lower supporter 120.

In this case, lubrication oil may be supplied between the slip surface 151 and the slanted surface 121 for smooth sliding motion of the slider 150 and the supporters 110 and 120.

The slider 150 is formed of a body 153 having the slip surface 151.

The body 153 may have a right triangular cross-section, and is inserted in the supporter mounting portion 111. If a vertex of the right triangle corresponds to the lowest end of the slanted surface 121, a corner disposed opposite to the vertex is protruded from the supporter mounting portion 111.

According to the present exemplary embodiment, the operation unit 170 selectively applies the operating force to the slider 150 so as to move the supporters 110 and 120 upwardly or downwardly in the supporter mounting portion 111. The operation unit 170 is rotatably mounted on the lower cylinder block 15 corresponding to the crankshaft 30.

The operation unit 170 includes a control shaft 171 rotatably mounted on the lower cylinder block 15 corresponding to the crankshaft 30 and a drive motor 175 supplying driving torque to the control shaft 171.

The control shaft 171 is provided with a plurality of cam members 173 connected to the slider 150 through the power delivery unit 190.

Here, each cam member 173 is an eccentric cam including a circular base 174a and a nose 174b eccentrically protruded from the base 174a.

The drive motor 175 is connected to the control shaft 171, and may be a servo motor.

The drive motor 175 is electrically connected to a controller and rotates clockwise or counterclockwise according to a control signal transmitted from the controller. The servo motor is well known to a person skilled in the art, and therefore, detailed description thereof will be omitted in this specification.

According to the present exemplary embodiment, the power delivery unit 190 connects the slider 150 to the cam member 173 of the control shaft 171. The power delivery unit 190 converts rotational motion of the cam member 173 into rectilinear motion and transmits the operating force of the operation unit 170 to the slider 150.

The power delivery unit 190 includes link members 191 pivotably connected to the slider 150 and the cam member 173 of the control shaft 171 respectively.

The link member 191 may have a rod shape, and link holes are formed at both ends of the link member 191 respectively. Both ends of the link member 191 are pivotably connected to the slider 150 and the cam member 173 through a link pin 195 engaged to the link hole, respectively.

One end of the link member 191 is pivotably connected to a protruded portion of the body 153 in the slider 150 described above, and the other end of the link member 191 is pivotably connected to the nose 174b of the cam member 173 of the control shaft 171.

Hereinafter, operation of the variable compression ratio apparatus 100 for a vehicle engine according to an exemplary embodiment of the present invention will be described in detail.

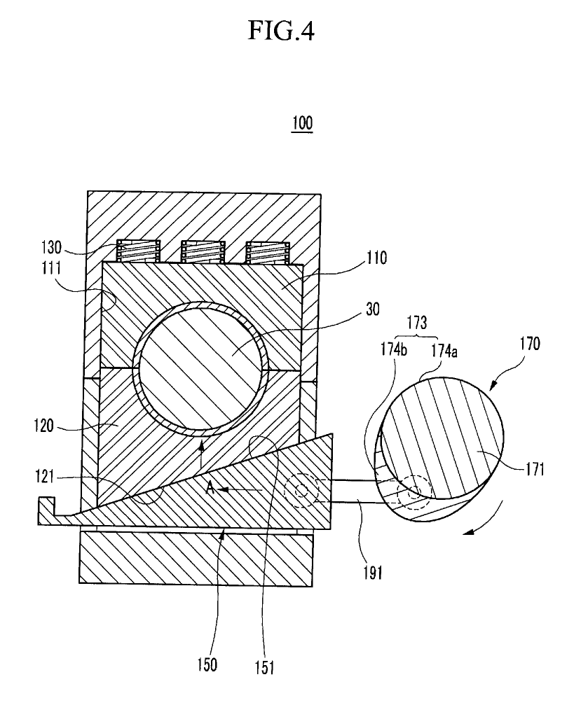

In a case that the engine 1 operates at a high compression ratio region (at a low load driving condition), the control shaft 171, in a state that the nose 174b of the cam member 173 faces to the downside in FIG. 4, rotates clockwisely by a predetermined angle through the control signal of the controller.

As the control shaft 171 rotates clockwisely, the nose 174b of the cam member 173 also rotates clockwisely. Accordingly, the torque of the control shaft 171 is transmitted to the slider 150 through the link member 191.

That is, since the link member 191 is pivotably connected respectively to the nose 174b of the cam member 173 and the slider 150, the rotational motion of the control shaft 171 is converted into the rectilinear motion of the link member 191 and the torque of the control shaft 171 is transmitted to the slider 150 through the link member 191.

The slider 150 receives the torque (that is, the operating force) of the control shaft 171 through the link member 191 and moves horizontally in the direction of the arrow “A” in FIG. 4.

At this state, the slip surface 151 of the slider 150 slides along the slanted surface 121 of the supporters 110 and 120 and moves horizontally in the direction of the arrow “A”. The slanted surface 121 slides along the slip surface 151 and moves upwardly.

Accordingly, the supporters 110 and 120 overcome the elastic force of the elastic member 130 and moves upwardly in the supporter mounting portion 111.

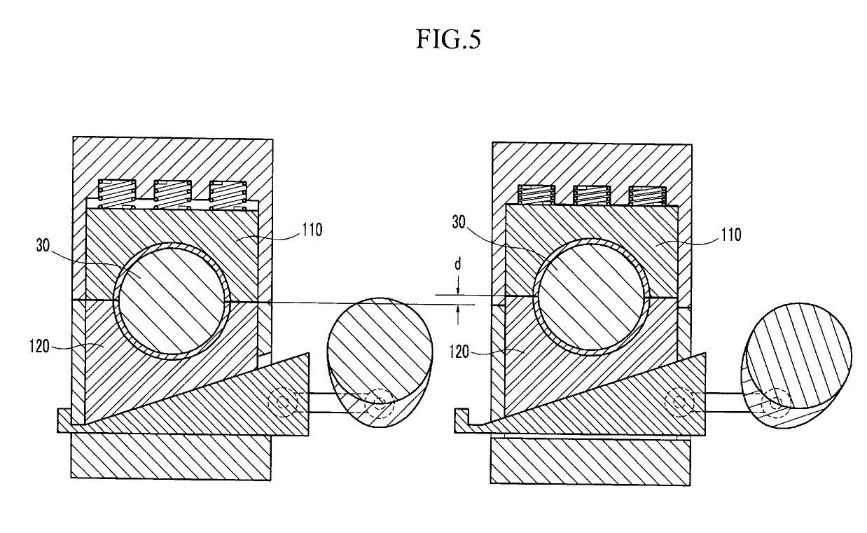

As the supporters 110 and 120 moves upwardly, the crankshaft 30 is raised by a predetermined height d as shown in FIG. 5 and high compression ratio is achieved according to the present exemplary embodiment.

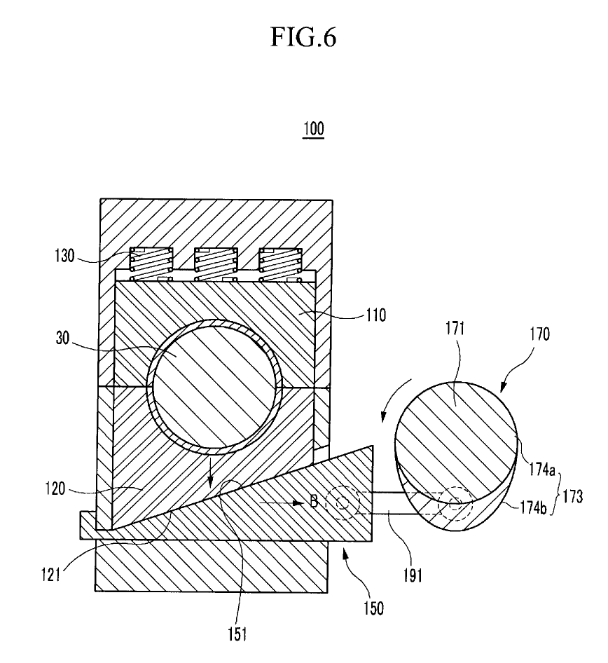

In a case that the engine 1 operates at a low compression ratio region (at a high load driving condition), the control shaft 171, in a state that the nose 174b of the cam member 173 faces to the slider 150, rotates counterclockwisely by the predetermined angle through the control signal of the controller and returns to its original position as shown in FIG. 6.

As the control shaft 171 rotates counterclockwisely, the nose 174b of the cam member 173 rotates counterclockwisely. Accordingly, the torque of the control shaft 171 is transmitted to the slider 150 through the link member 191.

That is, since the link member 191 is pivotably connected respectively to the nose 174b of the cam member 173 and the slider 150, the rotational motion of the control shaft 171 is converted into the rectilinear motion of the link member 191 and the torque of the control shaft 171 is transmitted to the slider 150 through the link member 191.

Accordingly, the slider 150 receives the torque (that is, the operating force) of the control shaft 171 through the link member 191 and moves horizontally in the direction of the arrow “B” in FIG. 6.

At this state, the slip surface 151 of the slider 150 slides along the slanted surface 121 of the supporters 110 and 120 and moves horizontally in the direction of the arrow “B”. The slanted surface 121 slides along the slip surface 151 and moves downwardly.

As the slider 150 moves horizontally in the direction of the arrow “B”, the supporters 110 and 120 move downwardly by the elastic force of the elastic member 130.

Here, the nose 174b of the cam member 173 faces to the downside in FIG. 6.

As the supporters 110 and 120 move downwardly, the crankshaft 30 is lowered by the predetermined height d as shown in FIG. 5 and low compression ratio is achieved according to the present exemplary embodiment.

Therefore, in a case that the engine 1 operates at the low load driving condition, top dead center of the piston 20 in the cylinder is raised by the predetermined height d and the compression ratio of the air-fuel mixture increases according to the present exemplary embodiment.

In addition, in a case that the engine 1 operates at the high load driving condition, the top dead center of the piston 20 in the cylinder is lowered by the predetermined height d and the compression ratio of the air-fuel mixture decreases.

Fuel consumption may be improved by increasing the compression ratio of the air-fuel mixture at the low load driving condition of the engine 1, and occurrence of knocking may be prevented and engine output may be improved by decreasing the compression ratio of the air-fuel mixture at the high load driving condition of the engine 1 according to the present exemplary embodiment.

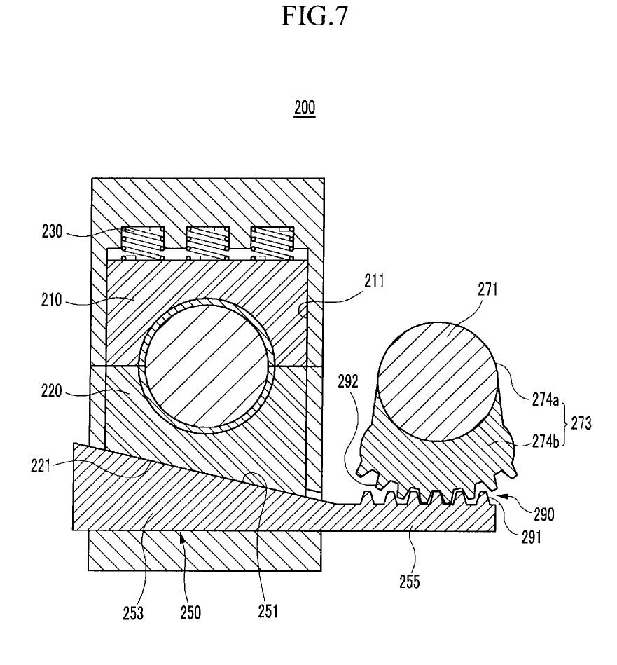

Referring to FIG. 7 to FIG. 10, a variable compression ratio apparatus for a vehicle engine according to another exemplary embodiment of the present invention will be described in detail. The variable compression ratio apparatus for a vehicle engine according to another exemplary embodiment of the present invention is similar to that according to an exemplary embodiment of the present invention.

FIG. 7 is a side cross-sectional view of a variable compression ratio apparatus for a vehicle engine according to another exemplary embodiment of the present invention.

Referring to the drawings, basic structures of the variable compression ratio apparatus in another exemplary embodiment is the same as that in an exemplary embodiment described above except a power delivery unit 290. According to the power delivery unit 290 of another exemplary embodiment, a slider 250 and a cam member 273 of a control shaft 271 are connected by a rack structure.

According to another exemplary embodiment of the present invention, a slanted surface 221 slanted upwardly from one side (the right side in FIG. 7) to the other side (the left side in FIG. 7) is formed on a lower surface of the lower supporter 220.

In addition, the slider 250 includes a body 253 having a slip surface 251 slidingly contacted to the slanted surface 221 of the lower supporter 220 in the supporter mounting portion 211 and an extended portion 255 facing from the body 253 to the control shaft 271 and extended to the outside of the supporter mounting portion 211.

In this case, the slip surface 251 of the body 253 corresponds to the slanted surface 221 of the lower supporter 220 and is slanted downwardly from the other side (the left side in FIG. 7) to the one side (the right side in FIG. 7).

In addition, the extended portion 255 is formed integrally with one side portion of the body 253, and is protruded to the outside of the supporter mounting portion 211 toward the cam member 273 of the control shaft 271.

According to the present exemplary embodiment, the power delivery unit 290 includes a first rack 291 integrally formed with the slider 250 and a second rack 292 integrally formed with the cam member 273 of the control shaft 271.

The first rack 291 is formed at the extended portion 255 of the slider 250, and the second rack 292 is engaged with the first rack 291 and is formed at the nose 274b of the cam member 273.

Other structures of the variable compression ratio apparatus 200 according to another exemplary embodiment of the present invention are the same as those of the variable compression ratio apparatus 100 according to an exemplary embodiment of the present invention, and thus detailed description thereof will be omitted in this specification.

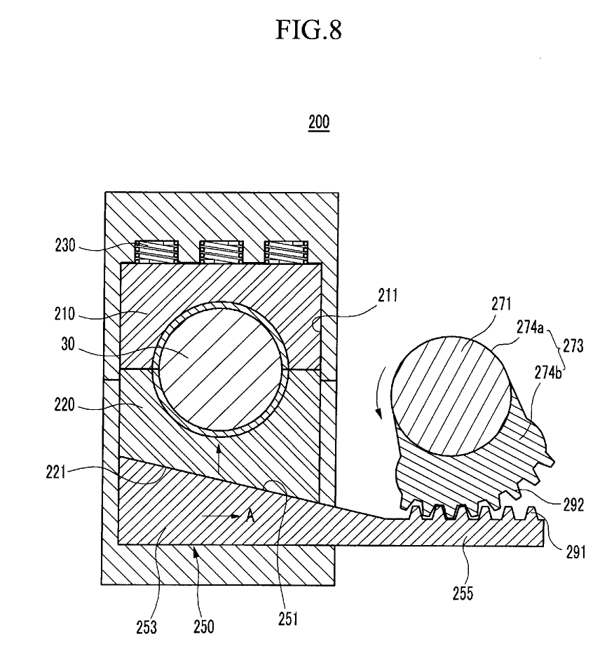

Hereinafter, operation of the variable compression ratio apparatus 200 for a vehicle engine according to another exemplary embodiment of the present invention will be described in detail. In a case that the engine 1 operates at the high compression ratio region (at the low load driving condition), the control shaft 271 rotates counterclockwisely by the predetermined angle, as shown in FIG. 8.

As the control shaft 271 rotates conuterclockwisely, the nose 274b of the cam member 273 rotates counterclockwisely. Accordingly, the torque of the control shaft 271 is transmitted to the slider 250 through the first rack 291 and the second rack 292.

That is, since the first rack 291 formed at the extended portion 255 of the slider 250 and the second rack 292 formed at the nose 274b of the cam member 273 are engaged with each other, rotational motion of the control shaft 271 is converted into rectilinear motion through the first and the second racks 291 and 292 and the torque of the control shaft 271 is transmitted to the body 253 of the slider 250.

Accordingly, the slider 250 receives the torque (the operating force) of the control shaft 271 and moves horizontally in the direction of the arrow “A” in FIG. 8.

At this state, the slip surface 251 of the slider 250 slides along the slanted surface 221 of the supporters 210 and 220 and moves horizontally in the direction of the arrow “A”. The slanted surface 221 slides along the slip surface 251 and moves upwardly.

Accordingly, the supporters 210 and 220 overcome the elastic force of the elastic member 230 and moves upwardly in the supporter mounting portion 211.

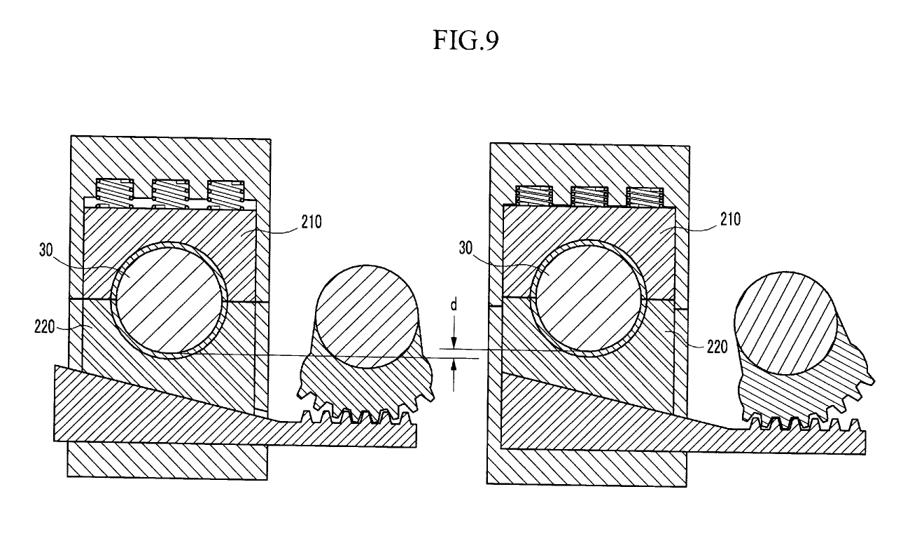

As the supporters 210 and 220 moves upwardly, the crankshaft 30 is raised by the predetermined height d as shown in FIG. 9 and high compression ratio is achieved according to the present exemplary embodiment.

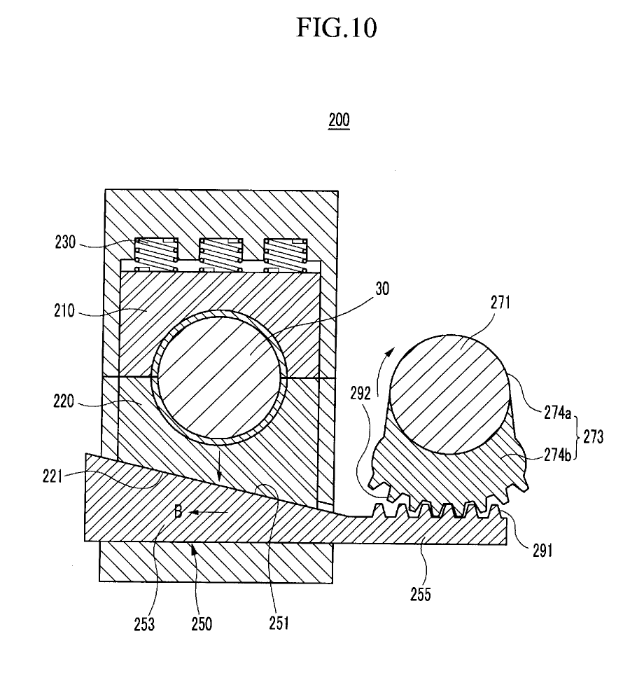

In a case that the engine 1 operates at the low compression ratio region (at the high load driving condition), the control shaft 271 rotates clockwisely by the predetermined angle through the control signal of the controller and returns to its original position as shown in FIG. 10.

As the control shaft 271 rotates clockwisely, the nose 274b of the cam member 273 also rotates clockwisely. Accordingly, the torque of the control shaft 271 is transmitted to the slider 250 through the first rack 291 and the second rack 292.

That is, since the first rack 291 formed at the extended portion 255 of the slider 250 and the second rack 292 formed at the nose 274b of the cam member 273 are engaged to each other, rotational motion of the control shaft 271 is converted into rectilinear motion through the first and the second racks 291 and 292 and the torque of the control shaft 271 is transmitted to the body 253 of the slider 250.

Accordingly, the slider 250 receives the torque (that is, the operating force) of the control shaft 271 and moves horizontally in the direction of the arrow “B” in FIG. 10.

At this state, the slip surface 251 of the slider 250 slides along the slanted surface 221 of the supporters 210 and 220 and moves horizontally in the direction of the arrow “B”. The slanted surface 221 slides along the slip surface 251 and moves downwardly.

As the slider 250 moves horizontally in the direction of the arrow “B”, the supporters 210 and 220 move downwardly by the elastic force of the elastic member 230.

As the supporters 210 and 220 move downwardly, the crankshaft 30 is lowered by the predetermined height d as shown in FIG. 9 and low compression ratio is achieved according to the present exemplary embodiment.

As described above, operation of the other constituent elements is the same in exemplary embodiments of the present invention, and thus detailed description thereof will be omitted.

As described above, since the present invention can control the compression ratio of an air-fuel mixture according to a driving condition of an engine, fuel consumption and output may be improved.

For convenience in explanation and accurate definition in the appended claims, the terms “upper”, “lower”, “downwardly”, and “upwardly” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable compression ratio apparatus for a vehicle engine that is mounted at the engine receiving combustion force of air-fuel mixture from a piston and rotating a crankshaft mounted between upper and lower cylinder blocks, and that changes compression ratio of the air-fuel mixture by changing a mounting height of the crankshaft according to a driving condition of the engine, wherein the mounting height is a distance between a cylinder head and the crankshaft, the variable compression ratio apparatus comprising:
a supporter having a lower surface formed of a slanted surface and mounted between the upper and lower cylinder blocks so as to be movable therein, wherein the crankshaft is rotatably coupled to the supporter;
an elastic member mounted at an upper portion of the supporter in the upper cylinder block so as to apply an elastic force to the supporter;
a slider slidingly contacted to the slanted surface of the supporter so as to move the supporter toward or away from a cylinder and thus control the mounting height and slidingly supported by the lower cylinder block so as to be movable in a perpendicular direction to the slider;
an operation unit rotatably mounted on the lower cylinder block and applying an operating force to the slider; and
a power delivery unit connecting the slider with the operation unit to transmit the operating force of the operation unit to the slider.

2. The variable compression ratio apparatus of claim 1, wherein the supporter is mounted at a supporter mounting portion located at a connecting position of the upper and lower cylinder blocks and is configured to be movable in the supporter mounting portion.

3. The variable compression ratio apparatus of claim 2, wherein the supporter mounting portion is a groove formed in the upper and lower cylinder blocks toward the cylinder to slidingly receive the supporter therein.

4. The variable compression ratio apparatus of claim 2, wherein the elastic member is mounted in at least one spring mounting recess formed on an upper end portion of the supporter mounting portion and is contacted with an upper surface of the supporter so as to apply the elastic force thereto.

5. The variable compression ratio apparatus of claim 1, wherein the slider is provided with a slip surface slidingly contacted with the slanted surface of the supporter so as to control the mounting height of the crankshaft.

6. The variable compression ratio apparatus of claim 1, wherein the operation unit comprises:
a control shaft provided with a cam member eccentrically connected to the slider through the power delivery unit; and
a drive motor connected to the control shaft and applying torque to the control shaft.

7. The variable compression ratio apparatus of claim 6, wherein the power delivery unit is provided with at least a link member pivotably connected to the slider and the cam member respectively.

8. The variable compression ratio apparatus of claim 6, wherein the power delivery unit comprises:
a first rack integrally formed at one end portion of the slider; and
a second rack integrally formed at the cam member and engaged with the first rack.

9. The variable compression ratio apparatus of claim 1, wherein the supporter comprises:
an upper supporter mounted in the upper cylinder block; and
a lower supporter provided with the slanted surface and mounted in the lower cylinder block.

10. The variable compression ratio apparatus of claim 9, wherein the upper supporter and the lower supporter are formed separately.

11. The variable compression ratio apparatus of claim 1, wherein the crankshaft is rotatably coupled to the supporter through a bearing.

12. The variable compression ratio apparatus of claim 11, wherein the supporter includes an upper supporter and a lower supporter and the bearing has a hollow cylindrical shape, an interior circumference and an exterior circumference of which have the same center, and comprises an upper bearing mounted in the upper supporter and a lower bearing mounted in the lower supporter.

13. The variable compression ratio apparatus of claim 12, wherein the upper bearing and the lower bearing are formed separately.

14. The variable compression ratio apparatus of claim 1, wherein the upper and lower cylinder blocks are formed monolithically.

15. A variable compression ratio apparatus for a vehicle engine that is mounted at the engine receiving combustion force of air-fuel mixture from a piston and rotating a crankshaft mounted between upper and lower cylinder blocks, and that changes compression ratio of the air-fuel mixture by changing a mounting height of the crankshaft according to a driving condition of the engine, wherein the mounting height is a distance between a cylinder head and the crankshaft, the variable compression ratio apparatus comprising:
a supporter provided with an upper surface, a lower surface formed of a slanted surface, and a middle portion at which the crankshaft are rotatably coupled, and being movable toward or away from a cylinder in the engine;
a slider provided with an upper surface corresponding to the slanted surface of the supporter and a flat lower surface, and being movable in a perpendicular direction to a movement direction of the supporter; and
an operation unit connected to the slider, and applying an operating force to the slider so as to move the slider in the perpendicular direction,
wherein a movement of the slider is converted into a movement of the supporter by the slanted surface of the supporter and the upper surface of the slider slidingly contacted with each other, and thereby the mounting height of the crankshaft is changed.

16. The variable compression ratio apparatus of claim 15, further comprising an elastic member applying elastic force against the operating force of the operation unit to the supporter.

17. The variable compression ratio apparatus of claim 15, wherein the operation unit selectively applies the operating force to the slider according to the driving condition of the engine.
